(19) United States
(12) Patent Application Publication
(10) Pub. No.: US 2026/0050923 A1
(43) Pub. Date: Feb. 19, 2026

(54) System and Method for Measuring and Mitigating Risk from Anomalous Financial Transactions

(71) Applicant: AMBEROON, INC., CUPERTINO, CA (US)

(72) Inventors: Shirish Netke, Cupertino, CA (US); Gurminder Singh, Cupertino, CA (US)

(73) Assignee: AMBEROON, INC., CUPERTINO, CA (US)

(21) Appl. No.: 18/803,478

(22) Filed: Aug. 13, 2024

(51) Int. Cl. G06Q 20/40

(52) U.S. Cl. CPC G06Q 20/4016

(57) ABSTRACT

A system and method for measuring and mitigating risk from anomalous financial transactions. The system assesses static and dynamic risks for financial assets, actors and transactions. Using both general information for context and specific information about a financial institution, the system includes a Context Generator, a Feature Generator, and an Analytics Engine which use machine learning features to produce forensic results about transactions and customers. The invention includes an interactive Sensemaker to assist users and analysts in compliance checking, reporting, and to identify anomalous transactions with minimal human operator intervention and low false positive results.

### COPYRIGHT STATEMENT

All material in this document, including the figures, is subject to copyright protections under the laws of the United States and other countries. The owner has no objection to the reproduction of this document or its disclosure as it appears in official governmental records. All other rights are reserved.

### TECHNICAL FIELD

The present invention relates generally to financial actors, transactions, banking, the financial industry, and compliance regulations in the financial sector.

### BACKGROUND OF THE INVENTION

Banks and financial service providers are required to report on suspicious assets, actors and transactions to regulatory authorities. This is a difficult problem primarily because of the sheer volume and multiple sources of data that need to be analyzed, and within that data, the signal to noise ratio is very high.

Legacy Anti Money Laundering (AML) systems (this is the current state-of-the-art) typically produce high volumes of alerts, of which a vast majority are false positives. Processing false alerts hurts the productivity of human resources, and to a large degree negates the expected benefit of using these systems in the first place—to automate the process. To address the high level of false positives generated by legacy AML systems, banks have increased compliance staffing levels up to 10 times in the past 5 years to ‘brute force’ process the alert volumes generated by rules-based legacy systems. A recent study by Lexis-Nexis indicated that in North America, more than 50% of the $31B spent on AML was labor costs. Increasing staff has helped make some banks become more effective but not more efficient.

Because AML rule-based systems currently used to help solve this problem report too many false positive cases, each requires a substantial amount of time and expertise to manually or semi-manually examine and causes inconvenience for bank customers as well. Also, because AML solutions are relatively static, as a result, bad actors can easily disguise legitimate or illicit transactions or can otherwise learn and adapt in order to “work around” and defeat AML fraud countermeasures.

The purpose of this invention is to provide a method and system to efficiently identify suspicious financial assets, actors and transactions in banks and other financial institutions with minimal false positives and thus, much lower operational costs.

### BRIEF SUMMARY OF THE INVENTION

By incorporating modern data analytics and machine learning techniques, including GenAI into AML systems, a financial institution significantly enhances its ability to detect and mitigate sophisticated money laundering schemes, while at the same time reducing the number of false positives. These techniques enable real-time transaction monitoring and utilize advanced data analysis to identify suspicious patterns like “layering” in transaction narratives. By integrating a risk-based approach, the bank aligns closely with regulatory guidelines which demand a nuanced understanding of risks associated with specific products, services, and geographic locations. This governance-driven process, which in turn drives systems, forms the basis for risk management, allowing the bank to manage operational risk efficiently and effectively. This approach not only improves detection accuracy but also ensures that compliance processes are more adaptive, efficient, and aligned with the dynamic nature of financial regulations and laundering tactics.

Since the context for evaluating risk evolves for many reasons, including political activity, governance rules, tactics and tools used by criminals, and natural disasters, the AML systems have to be able to adjust their risk context rapidly. A transaction that is acceptable today may not be so in a changed context.

The approach described in the present invention necessarily includes data processing hardware and software, data analytics, and machine learning techniques because human activity alone is not capable of (a) processing the massive sources of data containing relevant information and (b) perceiving intricate patterns that might indicate questionable activity worthy of further investigation. However, because the banking industry is currently not accepting of any fully automated processes, there is a necessary role for human operators pertaining to compliance checking and interactive sensemaking to identify anomalous transactions more precisely.

Systems and methods are provided to assess static and dynamic risks for financial assets, actors, and transactions. To achieve its objectives, this invention uses several different types of inputs including actors'profiles, historical transactional data, and geo-spatial information, as well as temporal transactional information aspects of assets, actors, and transactions. Data mining and machine learning techniques are applied to these inputs to achieve the stated objectives in time-and compute-efficient manners while preserving the privacy of sensitive data. The system can generate a variety of outputs that can be shared with various banks, regulatory agencies, and other financial institutions in an access-controlled fashion.

Advantages of this solution over the state of the art include very large reduction in false positive reports, reduced human costs, higher compliance rates, and integration with local operating procedures.

### BRIEF DESCRIPTION OF THE DRAWINGS

FIG. 1 is a diagram of the system in which multiple independent inputs are co-related and processed to generate insights in accordance with an embodiment of the present invention.

FIG. 2 shows an additional embodiment where a case management tool is configured into the invention with feedback into the learning components.

FIG. 3 shows an expanded view of the visualization feature for the user that contains processes for examination preparation, high risk review, alert management, and on-boarding (see FIG. 4).

FIG. 4 is an example of customized client on-boarding to show how the invention can be tailored to meet local process requirements while retaining acceptability regarding compliance and auditing.

### DETAILED DESCRIPTION OF THE INVENTION

The present invention relates to assessing static and dynamic risks for financial assets, actors and transactions based on data that comes from a number of proprietary and public data sources.

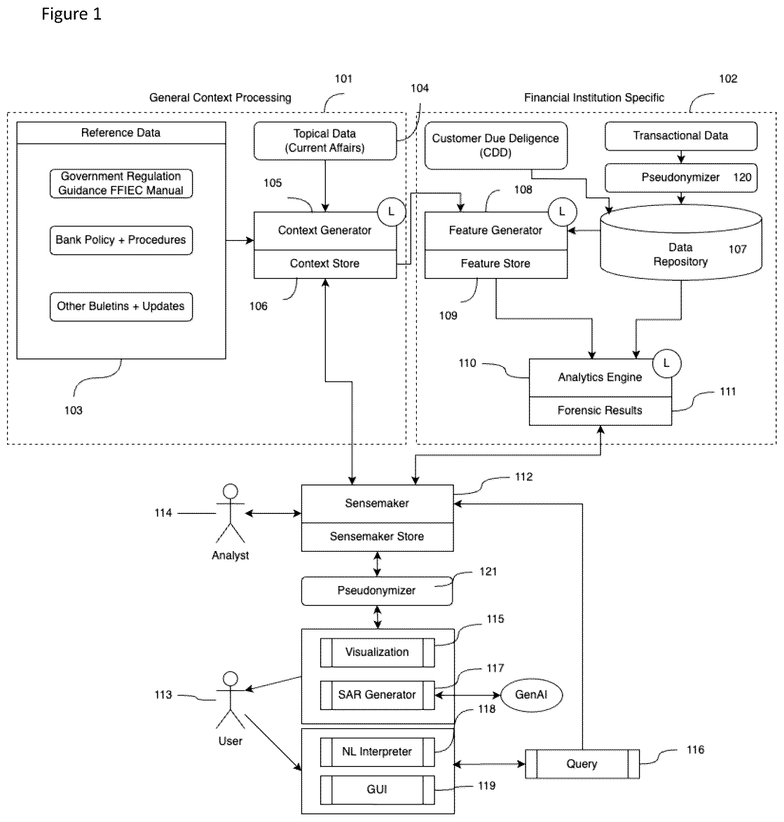

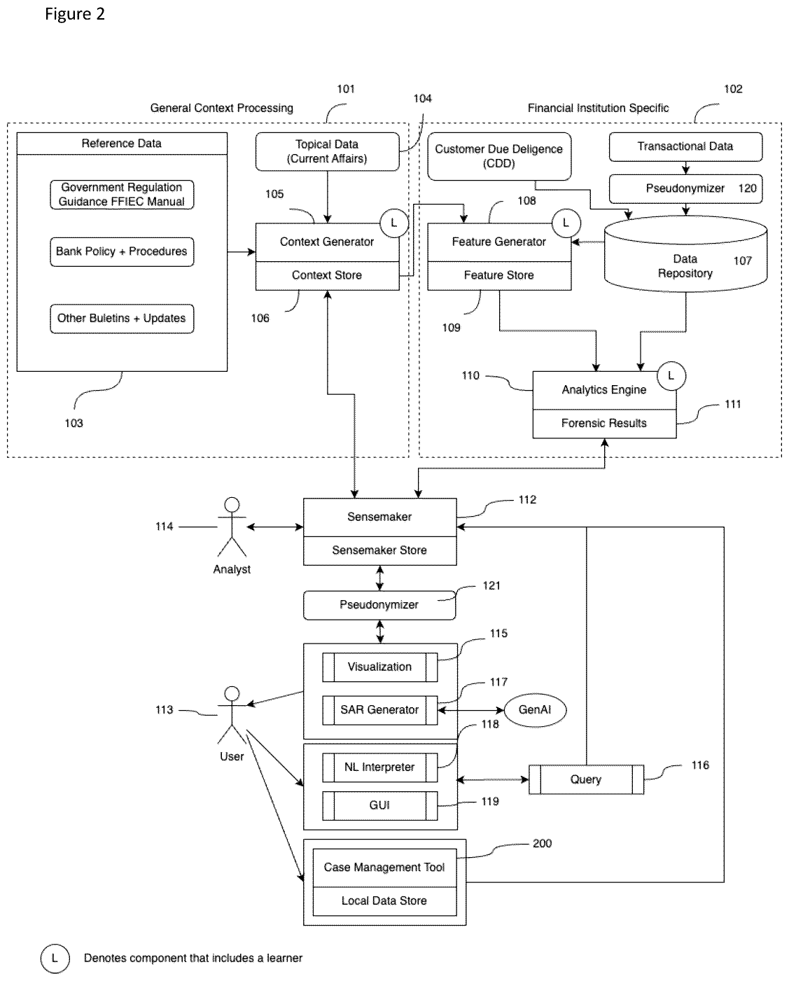

In this specification, the terms “actor” and “customer” are used interchangeably and refer to the person or entity whose transactions are being analyzed by the invention. The Customer Due Diligence (CDD) data shown in FIGS. 1 and 2 pertains to the actor or customer. The term “user” refers to the person using the Sensemaker visualizations and query feature to analyze a transaction or set of transactions from an actor or customer on behalf of a bank or financial institution. The term “learner” refers to a machine learning module and is not intended to be specific to any particular ML algorithm or device. Any ML module that builds models from data and can operate in a reinforcement more is suitable for this invention.

The system is described in FIG. 1. Sources of data fall into two primary categories, General Context Processing (101) and Financial Institution Processing (102). General context processing is not specific to any transaction or financial institution. Reference data (103) includes but is not limited to Government Regulation Guidance FFIEC Manual, Bank policy and procedures (general), and other bulletins and updates. Additionally, Topical Data (104) pertaining to current affairs, market news, and any other pertinent data source is also made available.

All data sources under general context processing are connected to the Context Generator (105). The Context Generator takes as its input unstructured data from both static and temporal sources of the general context processing and applied ML techniques to generate structured and unstructured data that characterizes the context for financial transactions risk. As an example, specific government sanctions in a country will lead to that country being associated with this risk.

The Context Generator processes both static and temporal data sources to manage financial transaction risks effectively. It contains a machine learner (learner) that uses a machine learning technique to clean, integrate, and extract key features from fixed data like regulatory guidelines and dynamic inputs like topical news items. This processed data is then organized into both structured formats, such as databases, and unstructured formats, like textual reports, to characterize the risks associated with financial transactions comprehensively. This enables stakeholders to understand and predict risks accurately, aiding in making informed decisions.

The results of the Context Generator are stored in the Context Store (106). The Context Store contains insights generated by the Context Generator using a combination of reference data and temporal data. The insights characterize referential data such as regulations, policies and procedures in the context of topical updates from temporal events as relevant to operational risk related to financial transactions. Note that the contents of the context store are generalizable for any transaction.

The Financial Institution Specific data sources (102) include but are not limited to Customer Due Diligence (CDD) data that is specific to a customer and Transactional Data that is specific to a transaction. These data may include core banking data that may include actors'transactions with a financial institution such as a bank. Such transactions may include a historical record of bank deposits, withdrawals, transfers and payments, actors'loan origination data such as mortgage application data, car loan application data, student loan data and other types of loan application data. Other data sources may include actors'profile data including credit scores, risk ratings, and financial performance data. Such data may be available from multiple sources some of which may be in the public domain such as the lists of individuals, groups, and entities who maybe terrorists and narcotics traffickers published by United States Office of the Foreign Assets Control (“OFAC”) of the US Department of the Treasury, and others may be available through other service providers such credit reference agencies that provide credit scores for actors. Input may come over a communications link in the form of structured digital data records from databases hosted in a private or public cloud.

All transactional data then may be processed in batch mode by the Pseudonymizer that tokenizes and hashes the data. This process (described in U.S. Pat. No. 12,032,720 which is hereby incorporated by reference) serves to hash sensitive data for safer processing and storage in the data repository (107). All sensitive data remains (in this case) with the financial institution, or the original holder of the sensitive information.

Both of these data sources are combined in the Data Repository (107). The Data Repository is a centralized place to store and manage data. It comprises both the relational data store to store the structured data and the graph data store to store the transaction link analysis data. This link analysis data is the basis of establishing a connection between bad or suspicious actors. This provides the basis of measuring risk associated with account holders. The Financial Institution Specific data along with the contents of the Context Store are transmitted to the Feature Generator (108).

The Feature Generator employs engineering techniques to create feature lists from the confluence of the context insights in the Context Store along with the specific data stored in the data repository pertaining to a specific customer and/or specific transaction. The Feature Generator may use GenAI to generate feature lists. The Feature Generator includes a machine learner that may be different from the machine learner employed by the Context Generator. These are pertinent to predicting risk outcomes related to financial transactions. These are captured in the Feature Store (109) that is maintained to provide an input to the Analytics Engine (110). Features generated from the context generator supplement legacy features in the machine learning models. The resulting feature list created by the Feature Generator is stored as Forensic Results (111).

The Analytics Engine (110) analyzes and investigates data for signs of fraud, misconduct, or other irregularities. It combines data analytics, machine learning, and investigative techniques to uncover patterns, anomalies, and correlations that may indicate fraudulent or suspicious activities. It has access to both the general data sources as well as those specific to a customer or transaction. One of the key inputs for the Analytics Engine are the features from the Feature Store, which represent the insights derived from the legacy and the topical data. The other input for the Analytics Engine comes from the Data Repository, which is structured in nature.

At this point in the process, the general data (101) and the specific data (102) have been processed via the Context Generator, the Feature Generator, and the Analytics Engine to produce Forensic Results. If the system were known to be 100% accurate, this would be the final step. Those results would be reported and acted upon. However, as discussed earlier, no system is 100% perfect and the banking industry therefore is unwilling to accept fully automated systems of any kind. Consequently, the present invention includes a “sensemaking” module that introduces a man-in-the-loop to optimize the results with minimal impact on the human operator.

If the Pseudonymizer (120) was used to tokenize and hash the data (see [0023] above), then the sensitive data must be unhashed so that the user (113) can read it. The Pseudonymizer (121) now operates in real-time mode to populate the Visualizations and the SAR.

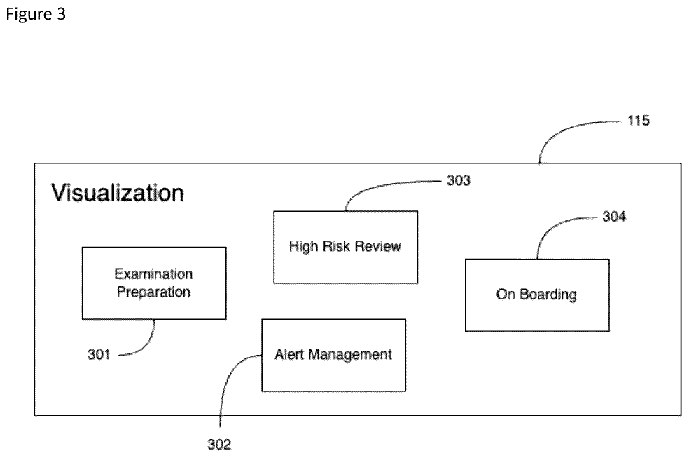

The Sensemaker (112) processes contextual information created by the Context Generator and interprets the Forensic Results to produce visualizations (115) for the user (113) or for an external analyst (114). FIG. 3 shows an expanded view of the visualizations that include:

Examination Preparation: the system is designed to ensure CDD/EDD and the related transactional analysis and supporting documentation is captured, current and reflective of the most complete analysis available for customers and accounts, in the context of independent testing and assurance models (including Internal Audit, and Regulatory Reviews/Requests).

High Risk Review (Enhanced Due Diligence (“EDD”) including Triggered or Periodic Customer Risk Review): High Risk Review is designed to ensure Risk thresholds are tailored to meet customer and account characteristics, and the analysis driving the risk review process accounts for key risk drivers (including new or dynamic aspects of a customer's or customer account′ products, services, customer types, industries and geographies).

Alert Management: Alert Management is designed to ensure the customer and account alert process evidences the existence of a fine-tuned AML risk program. Additionally, that evidence of Alert review and dispositioning is clear, well supported and documented, and SARs and CTRs are reviewed and filed timely and without errors.

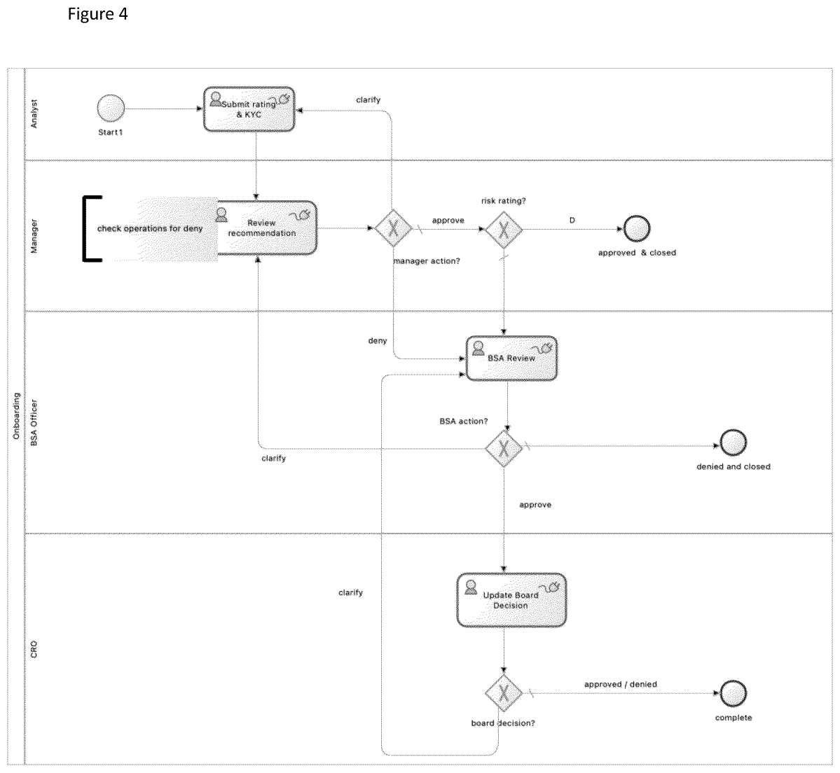

On-boarding: On-boarding is designed to ensure the Customer Identification Program (“CIP”) acts as an effective gateway for new customer and account reviews, is consistent and complete capturing required data elements, and also allows for effective and consistent CDD to comply with regulatory CDD/Beneficial Ownership rules and requirements and providing a sound and auditable platform to initiate the above three prongs/processes effectively. See FIG. 4 for the flow diagram for on-boarding.

Additionally, the Sensemaker allows the user to input queries (116) via the NL interpreter (118) and/or the GUI (119) related to specific transactions of interest which provides the ability to reach back into the Context Store and the Forensic Results (via the Sensemaker) as needed. The Sensemaker is also used to generate Suspicious Activity Reports (SAR) (117), providing essential data to facilitate this mandatory reporting.

The system generates Suspicious Activity Reports (SAR) which are based on data generated from transactions and manual-review-aided by the Sensemaker and Natural Language (NL) Interpreter (118). These SARs are submitted to the Financial Crimes Investigative Network (FinCEN) under the US Department of Treasury. This consists of structured data from case management tool and translation data. The SAR generator also writes a text narrative using LLM tools which is a critical part of the SAR submission process.

The Sensmaker aids the user in making decisions and recommends actions based on the constructed narratives and interpretations. Furthermore, because the Context Generator, the Feature Generator, and the Analytics Engine all contain a learner, feedback from the user can be used for reinforced learning to further improve the results thus reducing false positives. Many visualizations are possible. The system provides an interactive display where the user can probe the data which can reveal the underpinnings of the result being displayed, and also the user may query with “what if” questions to better understand the nature of the resulting display.

The system produces AML (anti-money laundering) Examiner Summaries for the analyst (114) that show (as a non-limiting example) (a) Transactional Values and Volumes for Large Cash Intensive business-mapping the originator customer/account details against transactional amounts, (b) Non-Bank Financial Institution (NBFI) Transactional Values—mapping originator customer/account details against transactional amounts, (c) Largest Non-Resident Alien (NRA) Transactional Values-mapping originator customer/account details against transactional amounts, (d) Largest Politically Exposed Person (PEP) Customer Transactional Values—mapping originator customer/account details against transactional amounts, and (e) Largest Non-Government Organizations (NGO)—mapping originator Ultimate Beneficial Owner (UBO)/customer/account details against transactional amounts.

AML Examiner Summaries may also provide AML support against BSA designated high-risk transactional red flags for instruments where the originator and beneficiary details pose significant risk, including (a) Top Cash Deposits, (b) Top Cash Withdrawals, (c) Top Outbound Wires, and (d) Top Inbound Wires.

The NL Interpreter (118) is used to translate natural language queries into SQL queries. This allows users to interact with databases using everyday language instead of writing complex SQL commands. LLMs can be integrated via the NL Interpreter and the GUI (119) to allow the user or analyst to interact using natural language.

### ADDITIONAL EMBODIMENTS

The system can execute on single transactions or in batch mode or multiple transactions as well as real-time processing to support interdiction efforts. Here, the system would execute in real time, reporting suspicious activity to law enforcement or other interested parties with detailed supporting evidence as to the nature of the transaction(s).

The system can include a connector to a case management tool (200, FIG. 2) where the user interaction again is fed back into the system (201) to support supervised learning processes.

The system can utilize special purpose processing hardware such as an application-specific integrated circuit (ASIC) that can be used for the Context Generator, the Feature Generator, the Analytics Engine, and the Sensemaker. While each of the learners indicated in FIG. 1 may be the same learner or a different learner, the corpus on which each learns is unique and is maintained separately.

Either or both of the Pseudonymizers (120 and 121) may also be a separate hardware component that contains a processor, local memory, and network connectors. Furthermore, a Pseudonymizer may be a custom ASIC having these same components.

Because all banks and financial institutions operate differently yet must conform to strict compliance rules, the invention allows for the tailoring of local processes. The process shown in FIG. 4 depicts client on-boarding which goes through a series of steps starting from initial due diligence performed by an Analyst and ending with a decision of approval or denial. The objective revolves around arriving at a decision of whether or not a client can be on-boarded based on risk rating and KYC inputs. The on-boarding process involves four users: Analyst, Manager, BSA Officer and the CRO (Chief Risk Officer). This is but one tailorable process in the present invention that allows for local operating procedures and policies to blend with required processes and compliance checks resulting in a custom process that is acceptable to auditors, banking officials, and government compliance officers.

### INDUSTRIAL APPLICATION

The present invention is intended for use in financial industries including but not limited to banking, investment, and securities markets. The invention is scalable such that it can be used for individual transactions and customers as might be suitable for a small bank, or can be used for large financial institutions that may handle hundreds of thousands or more transactions daily. It can be used in either a synchronous (real time) or asynchronous mode.

1. A system for measuring and mitigating risk from an anomalous financial transaction, the system comprising:
at least one connector to unstructured static and temporal reference data;
a processor having a network connection;
a context generator coupled to the at least one connector and to the processor, where the processor has a first learner and is configured to generate risk insights that are retained in a context store;
a pseudonymizer having a connector to transactional data related to the anomalous financial transaction, where the transactional data contains information pertaining to at least one specific transaction with one specific financial institution that includes protected information and where the pseudonymizer tokenizes and hashes the transactional data in batch mode by replacing fields containing the protected information with substituted data and maintaining a map relating the protected information with the substituted data;
a data repository data coupled to the pseudonymizer that receives the pseudonymized transactional data;
a feature generator coupled to the data repository, to the context store, and to the processor and having a second learner, wherein the processor is configured to create feature lists using GenAI that are retained in a feature store;
an analytics engine coupled to the processor having a third learner, where the processor is configured to combine the risk insights from the context store, the feature lists from the feature store, and data from the data repository to produce forensic results that indicate fraudulent and suspicious transactions; and
a sensemaker coupled to the context store, the forensic results, and to the processor;
a de-pseudonymizer coupled to the sensemaker that unhashes the tokenized transactional data in real-time mode by accessing the map and replacing the substituted data with the protected information in the transaction; and
where the processor is configured to produce a user interface that includes a visualization that combines general context of the context store with specific attributes of the anomolous financial transaction to identify fraudulent and suspicious transactions to a user.

2. The system of claim 1 wherein the context generator further includes at least one connector to topical data.

3. (canceled)

4. The system of claim 1 wherein the first pseudonymizer and the de-pseudonymizer are separate hardware components containing a processor, local memory, and network connectivity.

5. The system of claim 1 wherein the feature generator uses GenAI to create feature lists.

6. The system of claim 1 wherein the first, second, and third learners each contain a data cleaner, a data integrator, and a data extractor.

7. The system of claim 1 wherein the data repository further includes a connector to customer due diligence data.

8. The system of claim 1 wherein the sensemaker further includes a sensemaker store that retains results of an analysis.

9. The system of claim 1 wherein the sensemaker further includes an analyst interface that includes a feedback connector wherein an analyst can override the forensic results.

10. The system of claim 9 wherein the analyst override is transmitted back to the context generator and to the analytics engine for reinforced learning.

11. The system of claim 8 further including a query interface that accepts queries from the user into the sensemaker store, including the context store, the feature store, and the forensic results.

12. The system of claim 8 wherein the sensemaker further includes a natural language interpreter to allow the user to query the sensemaker using natural language.

13. The system of claim 1 further including a SAR generator that produces a suspicious activity report based on the results of the analysis.

14. (canceled)

15. (canceled)

16. The system of claim 1 further including case management tools with a feedback loop to the sensemaker for reinforced learning.

17. A computer-implemented method for analyzing, measuring, and mitigating risk from an anomalous financial transaction, the steps comprising:
transmitting reference data to a context generator;
processing the reference data with a first learner to generate risk insights that are stored in a context store;
pseudonymizing transactional data related to the anomalous financial transaction, where the transactional data contains information pertaining to at least one specific transaction with one specific financial institution that includes protected information, by tokenizing and hashing the transactional data in batch mode by replacing fields containing the protected information with substituted data and maintaining a map relating the protected information with the substituted data;
transmitting the pseudonymized transactional data to a data repository;
creating feature lists by processing the pseudonymized transactional data and the risk insights with a second learner;
storing the feature lists in a feature store;
creating forensic results by processing the risk insights, the feature lists, and the data from the data repository with a third learner;
transmitting the forensic results and the context store to a sensemaker;
de-pseudonymizing the transactional data by unhashing the tokenized transactional data in real-time mode by accessing the map and replacing the substituted data with the protected information in the transaction;
visualizing analysis results; and
querying, the sensemaker via a user interface to refine the analysis result of the anomalous financial transaction.

18. (canceled)
